(19) United States
(12) Patent Application Publication
(10) Pub. No.: US 2023/0013590 A1
(43) Pub. Date: Jan. 19, 2023

(54) TWIST LOCK CONVECTION MOTOR MOUNT

(71) Applicant: Haier US Appliance Solutions, Inc., Wilmington, DE (US)

(72) Inventor: Dasney Kirkland, Shelbyville, KY (US)

(21) Appl. No.: 17/376,765

(22) Filed: Jul. 15, 2021

(51) Int. Cl. F24C 15/32; F24C 7/06

(52) U.S. Cl. CPC F24C 15/325; F24C 7/062

(57) ABSTRACT

A motor assembly for a convection oven includes a motor mount bracket and a motor. The motor mount bracket includes a plurality of slots spaced radially from an axle hole. The motor includes a plurality of locking flanges complimentary to the plurality of slots. The motor is selectively attached to the motor mount bracket by inserting a respective locking flange into a respective slot and twisting the motor.

### FIELD OF THE INVENTION

The present subject matter relates generally to oven appliances, and more particularly to motor mounts for convection fan motors in convection equipped oven appliances.

### BACKGROUND OF THE INVENTION

Oven appliances generally include a cabinet with a cooking chamber positioned therein. The cooking chamber is configured for receipt of food articles for cooking. The oven appliance also includes a heating element for generating heat energy for cooking. The heating element can be, e.g., an electric resistance element or a gas burner. Certain oven appliances also include features for forcing movement of heated air within the cooking chamber. Such oven appliances are generally referred to as convection ovens.

In typical conventional ovens, heated air within the cooking chamber can be circulated with a fan when in a convection mode. The fan initiates a flow of heated air through a plurality of slots in a wall of the oven's cabinet. The fan is generally powered by a motor, typically either a one-direction motor or a two-direction motor. Conventionally, the motor is mounted to a bracket which is in turn mounted to a wall of the cooking chamber. However, assembly of the motor to the bracket is cumbersome and tedious, often including a plurality of fasteners. Additionally or alternatively, an accurate and proper assembly of the motor to the bracket requires precise alignment before inserting the fasteners, leading to incorrect attachment of the motor to the bracket. Further, current tolerances on locating holes and tabs between the motor and the bracket make alignment and assembly difficult.

Accordingly, an oven appliance that obviates one or more of the above-mentioned drawbacks would be beneficial. In particular, a mounting structure for motors with reduced parts and labor would be useful.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a motor assembly for an oven appliance is provided. The motor assembly may define a radial direction, an axial direction, and a circumferential direction. The motor assembly may include a motor including a plurality of motor feet extending from a motor body, each motor foot defining a locking flange; and a motor mount bracket. The motor mount bracket may include a bracket plate; an axle hole formed through the bracket plate; and a plurality of slots formed through the bracket plate for receiving the locking flanges. The plurality of slots may be spaced a predetermined distance from the axle hole along the radial direction. Each of the plurality of slots may define a receiving portion and a locking portion. The motor may be rotatable with respect to the motor mount bracket between a first position and a second position such that the motor is fixed to the motor mount bracket when in the second position.

In another exemplary aspect of the present disclosure, an oven appliance is provided. The oven appliance may include a chamber defining a rear wall, two opposing side walls, a top wall, and a bottom wall; a door to selectively open and close the chamber; and a motor assembly attached to one of the rear wall, the two opposing side walls, the top wall, or the bottom wall. The motor assembly may define a radial direction, an axial direction, and a circumferential direction. The motor assembly may include a convection motor including a plurality of motor feet extending from a motor body, each motor foot defining a locking flange; and a motor mount bracket. The motor mount bracket may include a bracket plate; an axle hole formed through the bracket plate; and a plurality of slots formed through the bracket plate for receiving the locking flanges. The plurality of slots may be spaced a predetermined distance from the axle hole along the radial direction. Each of the plurality of slots may define a receiving portion and a locking portion. The convection motor may be rotatable with respect to the motor mount bracket between a first position and a second position such that the convection motor is fixed to the motor mount bracket when in the second position.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front view of an oven appliance according to an exemplary embodiment of the present subject matter.

FIG. 2 provides a cross-sectional view of the oven appliance taken along the 2-2 axis of FIG. 1.

FIG. 3 provides a perspective, schematic view of one embodiment of an oven appliance according to the present disclosure, particularly illustrating the back wall of the oven appliance configured with a convection chamber assembly.

FIG. 4 provides a perspective view of an exemplary motor mount bracket according to an exemplary embodiment of the present disclosure.

FIG. 5 provides a front view of the exemplary motor mount bracket of FIG. 4.

FIG. 6 provides a perspective view of an exemplary motor according to an exemplary embodiment of the present disclosure.

FIG. 7 provides a close-up perspective view of a locking flange of a motor foot of the exemplary motor of FIG. 6.

FIG. 8 provides a rear view of the exemplary motor mount bracket of FIG. 5, with an exemplary motor attached thereto.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

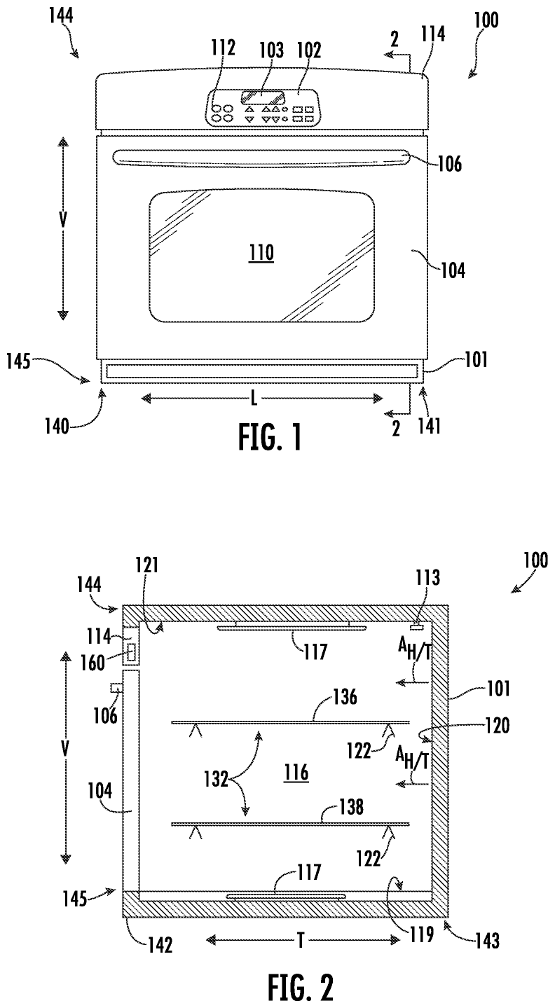

Referring to FIGS. 1 and 2, an exemplary embodiment of an oven appliance 100 for providing convection and microwave heating is shown according to the present disclosure. In particular, FIG. 1 provides a front view of the oven appliance 100. FIG. 2 provides a cross-sectional view of the oven appliance 100 taken along the 2-2 axis shown in FIG. 1. The oven appliance 100 includes a cabinet or housing 101 with a cooking chamber 116 positioned therein.

The cabinet 101 extends between a first side 140 (FIG. 1) and a second side 141 (FIG. 1) along a lateral direction L. Further, the cabinet 101 also extends between a front 142 (FIG. 2) and a back 143 (FIG. 2) along a transverse direction T. The cabinet 101 further extends between a top 144 and a bottom 145 along a vertical direction V. Transverse direction T is substantially perpendicular to lateral and vertical directions L, V. Thus, vertical direction V, lateral direction L, and transverse direction T are orthogonally oriented such that vertical direction V, lateral direction L, and transverse direction T form an orthogonal directional system.

Moreover, the chamber 101 has interior walls including opposing sidewalls 118, bottom wall 119, back wall 120, and top wall 121 that define cooking chamber 116. Bottom wall 119 and top wall 121 are spaced apart along the vertical direction V, and sidewalls 118 extend along the vertical direction V between top wall 121 and bottom wall 119. Back wall 120 extends between sidewalls 118 along the lateral direction L and also extends between top wall 121 and bottom wall 119 along the vertical direction V.

Sidewalls 118 include supports 122 (FIG. 2) for supporting oven racks 132 (FIG. 2) that may be selectively positioned within chamber 116. Oven racks 132 include a top rack 136 and a bottom rack 137. Top rack 136 is positioned above bottom rack 137 along the vertical direction V.

The oven appliance 100 also includes a door 104 with handle 106 that provides for opening and closing access to a cooking chamber 116. A user of the oven appliance 100 can place a variety of different items to be cooked in chamber 116 onto racks 132. Heating elements 117 may be positioned at the top and the bottom of chamber 116 to provide heat for cooking and cleaning. Such heating element(s) can be e.g., gas, electric, microwave, or a combination thereof. Other heating elements (not shown) could be located at other locations as well. A window 110 on door 104 allows the user to view e.g., food items during the cooking process.

Referring to FIG. 1, the oven appliance 100 includes a user interface 102 having a display 103 positioned on top panel 114 with a variety of controls 112. In certain embodiments, the interface 102 allows the user to select various options for the operation of oven appliance 100 including e.g., temperature, time, and/or various cooking and cleaning cycles. Operation of the oven appliance 100 can be regulated by a controller 160 (FIG. 2) that is operatively coupled i.e., in communication with, user interface panel 102, heating element(s), and other components of oven appliance 100 as will be further described.

For example, in response to user manipulation of the user interface panel 102, the controller 160 can operate heating element(s). The controller 160 can receive measurements from a temperature sensor 113 (FIG. 2) placed in cooking chamber 116 and e.g., provide a temperature indication to the user with display 103. By way of example, the controller 160 may include a memory and one or more processing devices such as microprocessors, CPUs, or the like, such as general or special purpose microprocessors operable to execute programming instructions or micro-control code associated with operation of appliance 100. The memory may represent random access memory such as DRAM, or read only memory such as ROM or FLASH. In one exemplary embodiment, the processor executes programming instructions stored in memory. The memory may be a separate component from the processor or may be included onboard within the processor.

The controller 160 may be positioned in a variety of locations throughout appliance 100. Thus, the controller 160 may be located under or next to the user interface 102 or otherwise within top panel 114. In an exemplary embodiment, input/output (“I/O”) signals are routed between the controller 160 and various operational components of appliance 100 such as heating element(s), controls 112, display 103, sensor(s), alarms, and/or other components as may be provided. In one exemplary embodiment, the user interface panel 102 may represent a general purpose I/O (“GPIO”) device or functional block.

Although shown with touch type controls 112, it should be understood that controls 112 and the configuration of the oven appliance 100 shown in FIG. 1 is provided by way of example only. More specifically, user interface 102 may include various input components, such as one or more of a variety of electrical, mechanical, or electro-mechanical input devices including rotary dials, push buttons, and touch pads. The user interface 102 may include other display components, such as a digital or analog display device designed to provide operational feedback to a user. The user interface 102 may be in communication with the controller 160 via one or more signal lines or shared communication busses. Also, the oven appliance 100 is shown as a wall oven but the present invention could also be used with other appliances such as e.g., a stand-alone oven, an oven with a stove-top, and other configurations as well.

In another embodiment, the oven appliance 100 may be equipped with features for selectively generating a forced flow of heated air within the cooking chamber 116 (e.g., using a fan or multiple fans). Thus, the oven appliance 100 is generally referred to as a convection oven. Such a flow of heated air can, e.g., decrease the required cooking temperature for food items, decrease the amount of time needed to cook food items, or assist in cooking food items more evenly.

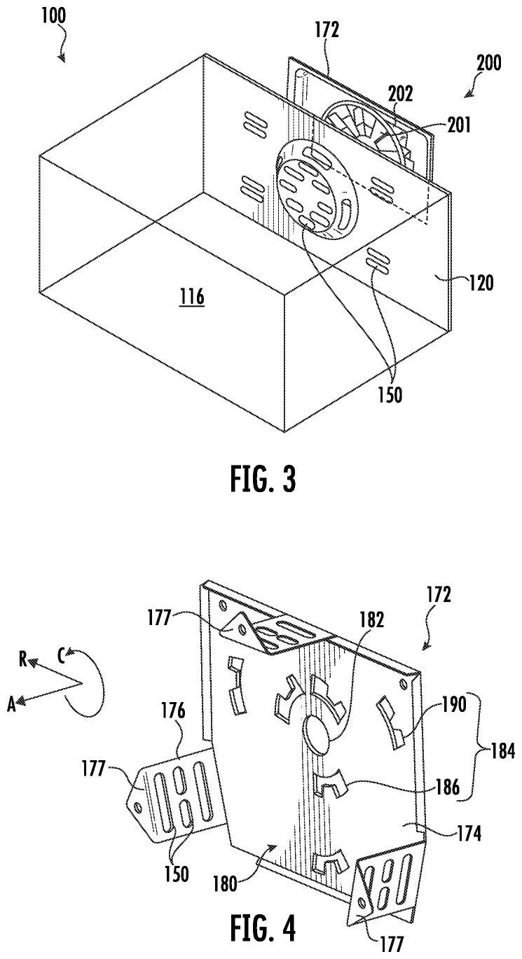

Referring now to FIG. 3, a partial, perspective view of the oven appliance 100 is illustrated according to the present disclosure. More particularly, FIG. 3 illustrates a front perspective view of the oven appliance 100 with the door 104 removed according to the present disclosure. As may be seen in FIG. 3, the back wall 120 may define a plurality of vents or apertures 150. As such, the plurality of apertures 150 is configured for directing a flow of heated air flow shown generally as A_{H/T} (FIG. 2). Thus, the flow of air A_{H/T} exits the plurality of apertures 150 flowing generally along the transverse direction T. However, in alternative exemplary embodiments, the plurality of apertures 150 may be defined in sidewalls 118 such that the flow of air A_{H/T} exits the plurality of apertures 150 flowing generally along the lateral direction L.

Moreover, the plurality of apertures 150 may have any suitable geometry and/or size. For example, as shown in FIG. 3, the plurality of apertures 150 may be elongated slots. Alternatively, the plurality of apertures 150 may be circular, triangular, oval, or any other suitable shape or combination of shapes. Further, the plurality of apertures 150 may each define a maximum dimension up to about 50 millimeters (mm) to allow convection air to flow out of the plurality of apertures 150. In such embodiments, the plurality of apertures 150 are large enough to provide sufficient convection heating to food items in the oven appliance 100.

In alternative exemplary embodiments, as will be understood by those skilled in the art, louvers, or slats (not shown) may be mounted adjacent the plurality of apertures 150. The louvers are configured for redirecting airflow, e.g., flow A_{H/T}. For example, the louvers can more evenly direct flow A_{H/T} throughout cooking chamber 116.

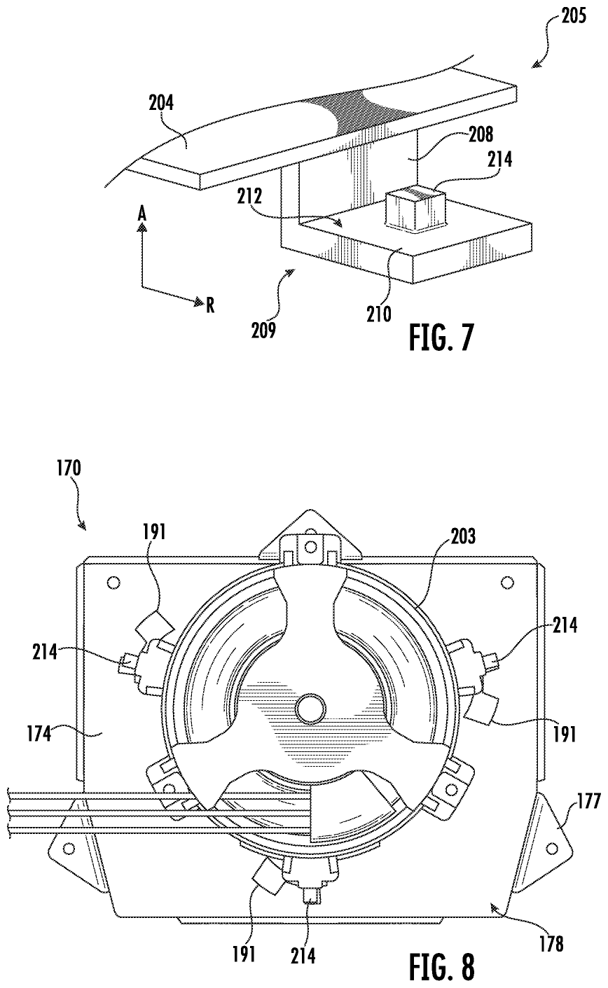

Referring now to FIGS. 4 through 8, a motor assembly 170 will be described. Motor assembly 170 may define a radial direction R, an axial direction A, and a circumferential direction C. In at least one example, axial direction A may be parallel with transverse direction T of oven appliance 100. Motor assembly 170 may be part of a convection chamber assembly 200 (FIG. 3), which may be attached to a wall of cooking chamber 116 (e.g., back wall 120). For example, in an embodiment, the oven appliance 100 may include a convection fan 201 mounted to cabinet 101 adjacent back wall 120, the top wall 121, or one of the opposing sidewalls 118, a cooling fan (not shown) positioned with the convection fan 201 (e.g., on the same motor axle), and a stirrer fan (not shown) mounted atop the cabinet 101. Further, the convection chamber assembly 200 may be positioned adjacent to the back wall 120 with the convection fan 201 being an axial fan 201. In further embodiments, the convection chamber assembly 200 (and therefore the convection fan) may be positioned within a manifold defined in a convection cover. Thus, in alternative embodiments, the convection chamber assembly 200 may also be secured to the top wall 121.

Motor assembly 170 may include a motor mount bracket 172. Motor mount bracket 172 may be configured to attach directly to back wall 120. For instance, motor mount bracket 172 may include a bracket plate 174 and a plurality of bracket legs 176. Bracket plate 174 may be a planar plate defining a motor face 178 and a fan face 180 opposite motor face 178. Motor face 178 may be provided on a rear of bracket plate 174 (e.g., along the axial direction A when motor mount bracket is attached to back wall 120). Motor mount bracket 172 may define an axle hole 182 formed through bracket plate 174 along the axial direction A (e.g., from motor face 178 to fan face 180). Axle hole 182 may be predominantly circular. Axle hole 182 may be formed so as to allow a rotating axle (e.g., a motor axle 218, FIG. 6) to pass therethrough.

The plurality of bracket legs 176 may include any suitable number of legs. For instance, as shown in FIG. 4, three bracket legs 176 may be included. Bracket legs 176 may extend along the axial direction A from bracket plate 174. In detail, bracket legs 176 may extend from an outer edge of bracket plate 174 along the axial direction A towards back wall 120. Each bracket leg 176 may include a mounting flange 177. Mounting flanges 177 may extend along the radial direction R. Accordingly, motor mount bracket 172 may be fastened to back wall 120 via mounting flanges 177. Additionally or alternatively, bracket legs 176 may include a plurality of vents 150 formed therethrough along the radial direction R. For instance, vents 150 may be similar to vents 150 formed through back wall 120.

Motor mount bracket 172 may further define a plurality of slots 184 formed through bracket plate 174 (e.g., along the axial direction A). Each of the plurality of slots 184 may be curved about axle hole 182 along the circumferential direction C. The plurality of slots 184 may include a plurality of inner slots 186 and a plurality of outer slots 190. The plurality of inner slots 186 may be spaced a first predetermined distance D1 away from axle hole 182. In detail, each of the plurality of inner slots 186 may be spaced the first predetermined distance D1 away from axle hole 182 along the radial direction R. For instance, the first predetermined distance D1 may be between 0.5 inches and 1.4 inches. Additionally or alternatively, the plurality of inner slots 186 may be spaced apart from one another along the circumferential direction C. The circumferential spacing of the plurality of inner slots 186 may not be equal. For instance, a space between a first inner slot and a second inner slot may be a first angular distance, while a space between the second inner slot and a third inner slot may be a second angular distance, the second angular distance being greater than the first angular distance. In another embodiment, the plurality of inner slots 186 are spaced equally about the axle hole 182 along the circumferential direction C.

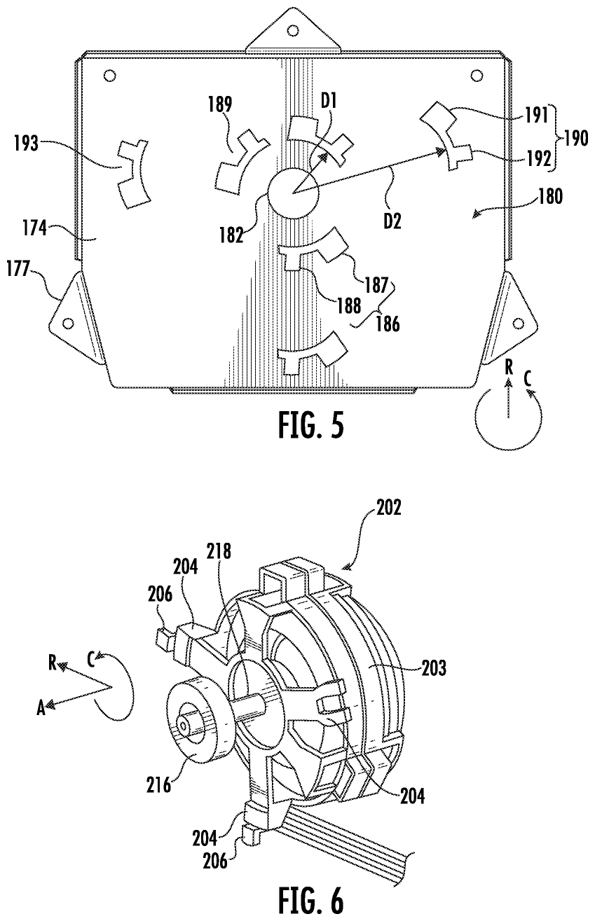

Each of the plurality of inner slots 186 may define two portions. For the sake of brevity, one inner slot 186 will be described herein, however it should be understood that the description will apply to each of the inner slots 186. Inner slot 186 may define a receiving portion 187 and a locking portion 188. In detail, with reference to FIG. 5, receiving portion 187 may be located at a first circumferential end of inner slot 186 and locking portion 188 may be located at an opposite circumferential end of inner slot 186. A width of receiving portion 187 may be greater than a width of locking portion 188 along the circumferential direction C. In some embodiments, a tab 189 may extend inward (e.g., towards axle hole 182) along the radial direction from an outer radial edge of inner slot 186. Tab 189 may separate receiving portion 187 from locking portion 188. Additionally or alternatively, tab 189 may extend outward (e.g., away from axle hole 182) along the radial direction from an inner radial edge of inner slot 186 to separate receiving portion 187 from locking portion 188. Thus, at least one radial edge may have an equal curve along the circumferential direction C about axle hole 182. In other words, the curve of one radial edge of inner slot 186 may be smooth.

The plurality of slots 184 may include the plurality of outer slots 190. The plurality of outer slots 190 may be spaced a second predetermined distance D2 away from axle hole 182. In detail, each of the plurality of outer slots 190 may be spaced the second predetermined distance D2 away from axle hole 182 along the radial direction R. For instance, the second predetermined distance D2 may be between 1.5 inches and 3 inches. Accordingly, the second predetermined distance D2 may be greater than the first predetermined distance D1. Additionally or alternatively, the plurality of outer slots 190 may be spaced apart from one another along the circumferential direction C. The circumferential spacing of the plurality of outer slots 190 may not be equal. For instance, a space between a first outer slot and a second outer slot may be a first angular distance, while a space between the second outer slot and a third outer slot may be a second angular distance, the second angular distance being greater than the first angular distance. In another embodiment, the plurality of outer slots 190 are spaced equally about the axle hole 182 along the circumferential direction C.

Each of the plurality of outer slots 190 may define two portions. For the sake of brevity, one outer slot 190 will be described herein, however it should be understood that the description will apply to each of the outer slots 190. Outer slot 190 may define a receiving portion 191 and a locking portion 192. In detail, with reference to FIG. 5, receiving portion 191 may be located at a first circumferential end of outer slot 190 and locking portion 192 may be located at an opposite circumferential end of outer slot 190. A width of receiving portion 191 may be greater than a width of locking portion 192 along the circumferential direction C. In some embodiments, a tab 193 may extend inward (e.g., towards axle hole 182) along the radial direction from an outer radial edge of outer slot 190. Tab 193 may separate receiving portion 191 from locking portion 192. Additionally or alternatively, tab 193 may extend outward (e.g., away from axle hole 182) along the radial direction from an inner radial edge of outer slot 190 to separate receiving portion 191 from locking portion 192. Thus, at least one radial edge may have an equal curve along the circumferential direction C about axle hole 182. In other words, the curve of one radial edge of outer slot 190 may be smooth.

Referring now to FIG. 6, motor assembly 170 may include a motor 202. Motor 202 may be a convection motor, for instance. In detail, motor 202 may operate a fan (e.g., convection fan 201, FIG. 3) to circulate heated air throughout cooking chamber 116. Accordingly, motor 202 may be a one-direction motor or a two direction motor, depending on the particular application. Motor 202 may include a motor body 203 and a plurality of motor feet 204. Each of the plurality of motor feet 204 may extend from motor body 203. For instance, each of the plurality of motor feet 204 may extend from motor body 203 along the radial direction R. Additionally or alternatively, each of the motor feet 204 may extend from motor body 203 along the axial direction A. The number of motor feet 204 may be equal to the number of slots 184 (e.g., either the number of inner slots 186 or the number of outer slots 190). Moreover, the circumferential spacing of motor feet 204 may be equal to the circumferential spacing of the plurality of slots 184 (e.g., either the inner slots 186 or the outer slots 190). Thus, the plurality of motor feet 204 may correspond to either the plurality of inner slots 186 or the plurality of outer slots 190. Hereinafter, the relationship between motor feet 204 (and locking flanges 206) will be described with reference to a single motor foot 204, a single locking flange 206, and an outer slot 190. However, it should be understood that the relationship may be identical for each motor foot 204, locking flange 206, and outer slot 190. Additionally or alternatively, the relationship may be identical for each motor foot 204, locking flange 206, and inner slot 186, according to a particular motor used.

Each of the plurality of motor feet 204 may include a locking flange 206. In detail, a distal end 205 of each motor foot 204 may define a locking flange 206. For the sake of brevity, a single locking flange 206 will be described herein, however it should be understood that the description applies to each locking flange 206 of each motor foot 204. Locking flange 206 may include a first portion 208 and a second portion 210. First portion 208 may extend along the axial direction A from the distal end 205 of motor foot 204. For instance, first portion 208 extends along the axial direction A away from motor body 203, toward bracket plate 174.

Second portion 210 may extend from a distal end 209 of first portion 208. For instance, second portion 210 extends along the radial direction R from the distal end 209 of first portion 208. A width of second portion 210 (e.g., along the circumferential direction C) may be less than a width of receiving portion 191, and greater than locking portion 192 (e.g., along the circumferential direction) of outer slot 190. Accordingly, second portion 210 may pass through receiving portion 191 of outer slot 190 along the axial direction A. Further, when motor 202 is rotated relative to bracket plate 174 (e.g., rotating second portion 210 towards locking portion 192), second portion 210 may become aligned with locking portion 192 along the axial direction A. In detail, a portion of an axial face 212 of second portion 210 of locking flange 206 may abut fan face 180 of bracket plate 174 adjacent to locking portion 192.

Locking flange 206 may include a protrusion 214. Protrusion 214 may extend from axial face 212 of locking flange 206 along the axial direction A. For instance, protrusion 214 extends toward motor body 203 along the axial direction A. A width of protrusion 214 (e.g., along the circumferential direction C) may be less than the width (e.g., along the circumferential direction C) of locking portion 192 of outer slot 190. Accordingly, when motor 202 is in the second position (e.g., when second portion 210 is overlapped with locking portion 192), protrusion 214 may be inserted into locking portion 192. In detail, motor body 203 may translate along the axial direction A away from bracket plate 174 while in the second position, such that protrusion 214 is inserted into locking portion 192. In some embodiments, protrusion 214 is then locked between a circumferential edge of outer slot 190 and tab 193 of outer slot 190. Advantageously, this prevents motor 202 from rotating with respect to bracket plate 174 during an operation of motor 202. Thus, connection stability and accuracy between motor 202 and bracket plate 174 may be maintained throughout a convection operation.

Motor assembly 170 may further include a resilient member 216. Resilient member 216 may be located between motor body 203 and bracket plate 174 (e.g., along the axial direction A). In some embodiments, resilient member 216 is a gasket provided around motor axle 218 of motor 202. Accordingly, resilient member 216 may be made of a resilient material, such as rubber, silicone, or the like. In some embodiments, resilient member 216 is a spring. Resilient member 216 may thus bias motor 202 away from motor mount bracket 172 along the axial direction. In this manner, when motor 202 is in the second position with respect to bracket plate 174, resilient member 216 biases motor body 203 away from bracket plate 174, which in turn allows protrusion 214 to be inserted into locking portion 188 of inner slot or locking portion 192 of outer slot 190 (e.g. depending on the size of the motor used). Advantageously, motor 202 is thus prevented from rotating (e.g., along the circumferential direction C) with respect to bracket plate 174.

According to the above-described embodiments, convection motors for convection ovens may be easily attached to brackets fixed to cooking chambers without the use of additional fasteners. Additionally or alternatively, a single bracket may be fixed to the cooking chamber to accommodate multiple sized motors utilizing two different sets of slots. Additionally or alternatively, motors may be attached with greater accuracy and stability, resulting in fewer opportunities for failure or misalignment.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A motor assembly for an oven appliance, the motor assembly defining a radial direction, an axial direction, and a circumferential direction, the motor assembly comprising:
a motor comprising a plurality of motor feet extending from a motor body, each motor foot defining a locking flange; and
a motor mount bracket comprising:
a bracket plate;
an axle hole formed through the bracket plate; and
a plurality of slots formed through the bracket plate for receiving the locking flanges, the plurality of slots being spaced a predetermined distance from the axle hole along the radial direction, wherein each of the plurality of slots defines a receiving portion and a locking portion, and wherein the motor is rotatable with respect to the motor mount bracket between a first position and a second position such that the motor is fixed to the motor mount bracket when in the second position.

2. The motor assembly of claim 1, wherein each of the plurality of slots is curved circumferentially about the axle hole.

3. The motor assembly of claim 2, wherein the locking flanges pass through the receiving portions of the plurality of slots when the motor is in the first position.

4. The motor assembly of claim 3, wherein the motor further comprises a protrusion extending from an axial face of the locking flange of each of the motor feet along the axial direction toward the motor body.

5. The motor assembly of claim 4, wherein the protrusions are selectively inserted into the locking portions of the plurality of slots when the motor is in the second position.

6. The motor assembly of claim 4, further comprising a resilient member provided between the motor and the motor mount bracket, the resilient member biasing the motor away from the motor mount bracket along the axial direction.

7. The motor assembly of claim 1, wherein the plurality of slots comprises a plurality of inner slots spaced a first predetermined distance from the axle hole along the radial direction and a plurality of outer slots spaced a second predetermined distance from the axle hole along the radial direction, the second predetermined distance being greater than the first predetermined distance.

8. The motor assembly of claim 7, wherein the plurality of inner slots comprises three inner slots spaced circumferentially about the axle hole.

9. The motor assembly of claim 8, wherein the plurality of motor feet comprises three motor feet, the three motor feet being complimentary to the three inner slots.

10. The motor assembly of claim 7, wherein the plurality of outer slots comprises three outer slots spaced circumferentially about the axle hole.

11. The motor assembly of claim 10, wherein the plurality of motor feet comprises three motor feet, the three motor feet being complimentary to the three outer slots.

12. The motor assembly of claim 1, wherein the oven appliance is a convection oven and the motor is a convection motor.

13. An oven appliance, comprising:
a chamber defining a rear wall, two opposing side walls, a top wall, and a bottom wall;
a door to selectively open and close the chamber; and
a motor assembly attached to one of the rear wall, the two opposing side walls, the top wall, or the bottom wall, the motor assembly defining a radial direction, an axial direction, and a circumferential direction, the motor assembly comprising:
a convection motor comprising a plurality of motor feet extending from a motor body, each motor foot defining a locking flange; and
a motor mount bracket comprising:
a bracket plate;
an axle hole formed through the bracket plate; and
a plurality of slots formed through the bracket plate for receiving the locking flanges, the plurality of slots being spaced a predetermined distance from the axle hole along the radial direction, wherein each of the plurality of slots defines a receiving portion and a locking portion, and wherein the convection motor is rotatable with respect to the motor mount bracket between a first position and a second position such that the convection motor is fixed to the motor mount bracket when in the second position.

14. The oven appliance of claim 13, wherein each of the plurality of slots is curved circumferentially about the axle hole.

15. The oven appliance of claim 14, wherein the locking flanges pass through the receiving portions of the plurality of slots when the convection motor is in the first position.

16. The oven appliance of claim 15, wherein the convection motor further comprises a protrusion extending from an axial face of the locking flange of each of the plurality of motor feet along the axial direction, wherein the protrusions are selectively inserted into the locking portions of the plurality of slots when the convection motor is in the second position.

17. The oven appliance of claim 16, further comprising a resilient member provided between the convection motor and the motor mount bracket, the resilient member biasing the convection motor away from the motor mount bracket along the axial direction.

18. The oven appliance of claim 13, wherein the plurality of slots comprises a plurality of inner slots spaced a first predetermined distance from the axle hole along the radial direction and a plurality of outer slots spaced a second predetermined distance from the axle hole along the radial direction, the second predetermined distance being greater than the first predetermined distance.

19. The oven appliance of claim 18, wherein the plurality of inner slots comprises three inner slots spaced circumferentially about the axle hole, and wherein the plurality of motor feet comprises three motor feet, the three motor feet being complimentary to the three inner slots.

20. The oven appliance of claim 7, wherein the plurality of outer slots comprises three outer slots spaced circumferentially about the axle hole, and wherein the plurality of motor feet comprises three motor feet, the three motor feet being complimentary to the three outer slots.
